(19) United States
(12) Patent Application Publication
(10) Pub. No.: US 2026/0190030 A1
(43) Pub. Date: Jul. 2, 2026

(54) METHOD AND APPARATUS FOR TRANSMITTING INDICATION INFORMATION, AND READABLE STORAGE MEDIUM

(71) Applicant: BEIJING XIAOMI MOBILE SOFTWARE CO., LTD., Beijing (CN)

(72) Inventor: Ting FU, Beijing (CN)

(73) Assignee: BEIJING XIAOMI MOBILE SOFTWARE CO., LTD., Beijing (CN)

(21) Appl. No.: 19/127,290

(22) PCT Filed: Nov. 9, 2022
(86) PCT No.: PCT/CN2022/130945

§ 371 Date: May 5, 2025

(51) Int. Cl. H04W 52/02

(52) U.S. Cl. CPC H04W 52/0235

(57) ABSTRACT

Provided in the present disclosure are a method and apparatus for transmitting indication information, and a readable storage medium. The method includes: receiving indication information sent by a network device, where the indication information is used for indicating a physical downlink control channel (PDCCH) skipping duration in the form of a non-numerical value; and performing PDCCH skipping according to the indication information.

### CROSS-REFERENCE TO RELATED APPLICATIONS

The present application is a U.S. National Stage of International Application No. PCT/CN2022/130945, filed on Nov. 9, 2022, the content of which is incorporated by reference herein in its entirety for all purposes.

### TECHNICAL FIELD

The present disclosure relates to the field of wireless communication technologies, and in particular to method and device for transmitting indication information and a non-transitory computer-readable storage medium.

### BACKGROUND

In Release 17 (R17) of the 3rd Generation Partnership Project (3GPP), Physical Downlink Control Channel Skipping (PDCCH skipping) was introduced. According to PDCCH skipping, the base station can instruct the UE to skip PDCCH monitoring during a set period. During this set period, the user equipment (UE) does not need to monitor the PDCCH and can be in a sleep state, thereby achieving energy saving.

In PDCCH skipping, the network device can dynamically indicate the duration for skipping PDCCH monitoring (PDCCH skipping duration) through downlink control information (DCI).

### SUMMARY

The present disclosure provides method and device for transmitting indication information and a non-transitory computer-readable storage medium.

According to a first aspect, the present disclosure provides a method for receiving indication information, performed by a user equipment, including:
receiving indication information sent by a network device, where the indication information is configured to indicate a duration for skipping physical downlink control channel PDCCH monitoring in a form of non-numerical value; and
skipping PDCCH monitoring according to the indication information.

According to a second aspect, the present disclosure provides a method for sending indication information, performed by a network device, including:
sending indication information to a user equipment, where the indication information is configured to indicate a duration for skipping physical downlink control channel PDCCH monitoring in a form of non-numerical value; and
from an effective timing of the indication information, suspending PDCCH transmission.

According to a third aspect, the present disclosure provides a device for receiving indication Information. The device can be configured to perform steps performed by the user equipment according to the above first aspect or any possible design in the first aspect. The user equipment can achieve the functions in the above methods by forms of hardware structure, software module or hardware structure plus software module.

When achieving the device of the third aspect by software modules, the device may include a transceiver module and a processing module, which are coupled to each other. The transceiver module is configured to support the communication device to communicate, and the processing module is used for the communication device to perform operations, such as generating information/message to be sent, or process the received signal to obtain information/message.

When performing steps according to the first aspect, the transceiver module is configured to receive indication information sent by a network device, where the indication information is configured to indicate a duration for skipping physical downlink control channel PDCCH monitoring in a form of non-numerical value; and
the processing module is configured to skip PDCCH monitoring according to the indication information.

According to a fourth aspect, the present disclosure provides a device for sending indication information. The device can be configured to perform steps performed by the network device according to the above second aspect or any possible design in the second aspect. The network device can achieve the functions in the above methods by forms of hardware structure, software module or hardware structure plus software module.

When achieving the device of the fourth aspect by software modules, the device may include a transceiver module and a processing module, which are coupled to each other. The transceiver module is configured to support the communication device to communicate, and the processing module is used for the communication device to perform operations, such as generating information/message to be sent, or process the received signal to obtain information/message.

When performing steps according to the second aspect, a transceiver module is configured to send indication information to a user equipment, where the indication information is configured to indicate a duration for skipping physical downlink control channel PDCCH monitoring in a form of non-numerical value; and
a processing module is configured to suspend PDCCH transmission from an effective timing of the indication information.

According to a fifth aspect, the present disclosure provides a communication device, including a processor and a memory, where the memory is configured to store a computer program; and the processor is configured to execute the computer program to implement the method according to the first aspect or any possible design in the first aspect.

According to a sixth aspect, the present disclosure provides a communication device, including a processor and a memory, where the memory is configured to store a computer program; and the processor is configured to execute the computer program to implement the method according to the second aspect or any possible design in the second aspect.

According to a seventh aspect, the present disclosure provides a non-transitory computer-readable storage medium, where the non-transitory computer-readable storage medium stores instructions, and when the instructions are called and executed on a computer, the computer executes the method according to the first aspect or any possible design in the first aspect.

According to an eighth aspect, the present disclosure provides a non-transitory computer-readable storage medium, where instructions are stored in the non-transitory computer-readable storage medium, and when the instructions are called and executed on a computer, the computer executes the method according to the second aspect or any possible design in the second aspect.

It is to be understood that the foregoing general description and the following detailed description are exemplary and explanatory only and are not restrictive of the present disclosure.

### BRIEF DESCRIPTION OF THE DRAWINGS

The drawings described herein are used to provide a further understanding of the embodiments of the present disclosure and constitute a part of the present application. The schematic embodiments of the embodiments of the present disclosure and their descriptions are used to explain the embodiments of the present disclosure and do not constitute an improper limitation on the embodiments of the present disclosure. In the drawings:

The drawings herein are incorporated into the specification and constitute a part of the specification, showing embodiments that conform to the embodiments of the present disclosure and are used together with the specification to explain the principles of the embodiments of the present disclosure.

FIG. 1 is a schematic diagram of a wireless communication system architecture provided by an embodiment of the present disclosure;

FIG. 2 is a flow chart of a method for transmitting indication information according to an example embodiment;

FIG. 3 is a flow chart of a method for receiving indication information according to an example embodiment;

FIG. 4 is a flow chart of another method for receiving indication information according to an example embodiment;

FIG. 5 is a flow chart of another method for receiving indication information according to an example embodiment;

FIG. 6 is a schematic diagram of a duration for skipping PDCCH monitoring according to an example embodiment;

FIG. 7 is a flow chart of a method for sending indication information according to an example embodiment;

FIG. 8 is a block diagram of a device for receiving indication information according to an example embodiment;

FIG. 9 is a block diagram of a user equipment according to an example embodiment;

FIG. 10 is a block diagram of a device for sending indication information according to an example embodiment;

FIG. 11 is a block diagram of a communication device according to an example embodiment.

### DETAILED DESCRIPTION

The embodiments of the present disclosure are now further described in conjunction with the drawings and specific embodiments.

The example embodiments will be described in detail here, and examples thereof are shown in the drawings. When the following description refers to the drawings, unless otherwise indicated, the same numbers in different drawings represent the same or similar elements. The embodiments described in the following example embodiments do not represent all embodiments consistent with the embodiments of the present disclosure. Instead, they are only examples of devices and methods consistent with some aspects of the present disclosure as detailed in the attached claims.

The terms used in the embodiments of the present disclosure are only for the purpose of describing specific embodiments and are not intended to limit the embodiments of the present disclosure. The singular forms “a”, “an” and “the” used in the embodiments of the present disclosure and the attached claims are also intended to include plural forms unless the context clearly indicates other meanings. It should also be understood that the term “and/or” used herein refers to and includes any or all possible combinations of one or more associated listed items.

It should be understood that although the terms first, second, third, etc. may be used in the embodiments of the present disclosure to describe various information, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the words “if” as used herein may be interpreted as “upon . . . ” or “when . . . ” or “in response to determining”.

The embodiments of the present disclosure are described in detail below, and examples of the embodiments are shown in the accompanying drawings, where the same or similar reference numerals throughout represent the same or similar elements. The embodiments described below with reference to the accompanying drawings are examples and are intended to be used to explain the present disclosure, and cannot be understood as limiting the present disclosure.

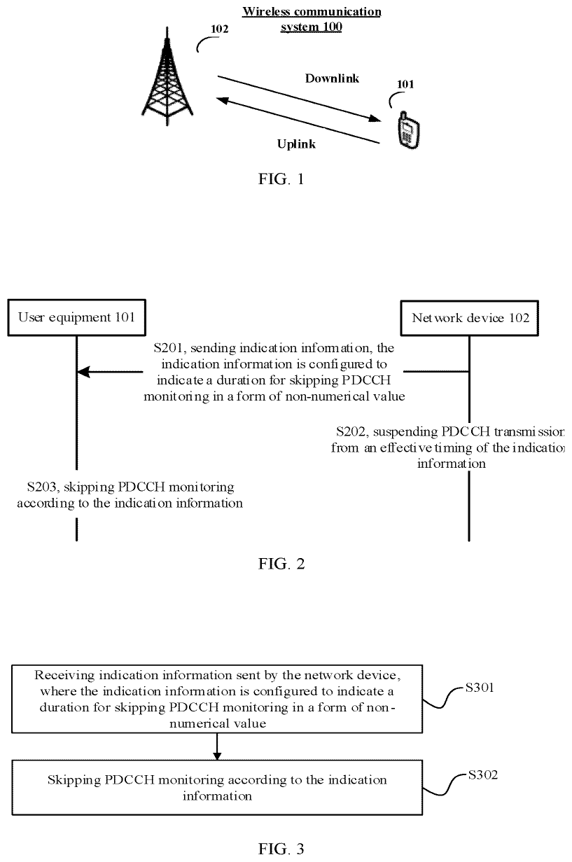

As shown in FIG. 1, a method for transmitting indication information provided by an embodiment of the present disclosure may be applied to a wireless communication system 100. The wireless communication system 100 may include a user equipment 101 and a network device 102. The user equipment 101 is configured to support carrier aggregation and may be connected to multiple carrier units of the network device 102, including a primary carrier unit and one or more secondary carrier units.

It should be understood that the above wireless communication system 100 may be applicable to both low-frequency scenarios and high-frequency scenarios. The application scenarios of the wireless communication system 100 include but are not limited to the long term evolution (LTE) system, the LTE frequency division duplex (FDD) system, the LTE time division duplex (TDD) system, the worldwide interoperability for micro wave access (WIMAX) communication system, the cloud radio access network (CRAN) system, the future fifth generation (5G) system, the new radio (NR) communication system or the future evolved public land mobile network (PLMN) system, etc.

The user equipment 101 shown above can be a terminal, an access terminal, a terminal unit, a terminal station, a mobile station (MS), a remote station, a remote terminal, a mobile terminal, a wireless communication device, a terminal agent or a terminal device, etc. The user equipment 101 can have a wireless transceiver function, which can communicate with one or more network devices in one or more communication systems (such as wireless communication) and receive network services provided by the network devices, where the network devices include but are not limited to the illustrated network device 102.

The user equipment (UE) 101 can be a cellular phone, a cordless phone, a session initiation protocol (SIP) phone, a wireless local loop (WLL) station, a personal digital assistant (PDA) device, a handheld device with wireless communication function, a computing device or other processing device connected to a wireless modem, a vehicle-mounted device, a wearable device, a terminal device in a future 5G network, or a terminal device in a future evolved PLMN network, etc.

The network device 102 can be an access network device (or access network site). The access network device refers to a device that provides network access function, such as a radio access network (RAN) base station, etc. The network device 102 can specifically include a base station (BS), or a base station and a wireless resource management device for controlling the base station, etc. The network device 102 can further include a relay station (relay device), an access point, a base station in a future 5G network, a base station in a future evolved PLMN network, or an NR base station, etc. The network device 102 can be a wearable device or a vehicle-mounted device. The network device 102 may also be a communication chip with a communication module.

For example, the network device 102 includes, but is not limited to, a next generation base station (gnodeB, gNB) in 5G, an evolved node B (eNB) in an LTE system, a radio network controller (RNC), a node B (NB) in a WCDMA system, a wireless controller under a CRAN system, a base station controller (BSC), a base transceiver station (BTS) in a GSM system or a CDMA system, a home base station (e.g., home evolved nodeB, or home node B, HNB), a baseband unit (BBU), a transmitting and receiving point (TRP), a transmitting point (TP) or a mobile switching center, etc.

In the PDCCH skipping scenario, the network device can configure up to 3 candidate values for the duration for skipping PDCCH monitoring (PDCCH skipping duration), However, the network device 102 cannot accurately predict the arrival time of the downlink data. Therefore, when the network device uses DCI to indicate the duration for skipping PDCCH monitoring, there is a problem that the indicated duration does not match the actual service flow well.

For example, the network device 102 indicates a longer duration for skipping PDCCH monitoring, but the downlink data has arrived before the duration ends, then the network device 102 needs to wait until the duration ends before starting the scheduling of the downlink data, which leads to an increase in data transmission delay.

For another example, the network device 102 indicates a shorter duration for skipping PDCCH monitoring, but the downlink data has not arrived after the duration ends, then the user equipment 101 needs to perform unnecessary PDCCH monitoring, resulting in an energy waste of the user equipment 101.

Therefore, it is necessary to solve problems such as wasting energy or increasing delay, etc. caused by inappropriate duration for skipping PDCCH monitoring.

The embodiment of the present disclosure provides a method for transmitting indication information, referring to FIG. 2, which is a method for transmitting indication information according to an example embodiment. As shown in FIG. 2, the method includes steps S201 to S203, specifically:

Step S201, a network device 102 sends indication information to a user equipment 101, the indication information is configured to indicate a duration for skipping physical downlink control channel PDCCH monitoring in a form of non-numerical value.

Step S202, the network device 102 suspends PDCCH transmission from an effective timing of the indication information.

Step S203, the user equipment 101 skips PDCCH monitoring according to the indication information.

In some possible implementations, when the network device 102 configures the duration for skipping PDCCH monitoring with a non-numerical value, it indicates that the network device 102 does not indicate a specific duration and does not determine when the user equipment 101 needs to be woken up.

In one example, the indication information occupies 2 bits, and when the 2-bit value is a first value, it indicates skipping PDCCH monitoring, and the skipping duration is a non-numerical value.

For example, referring to Table 1, the first value is 11. When the 2-bit value is 11, it indicates the duration for skipping PDCCH monitoring in a non-numeric value. When the 2-bit value is other values, it can indicate 3 candidate duration values accordingly.

TABLE 1

| Bits | Duration |
|---|---|
| 00 | 1 |
| 01 | 2 |
| 10 | 3 |
| 11 | Non-numerical value |

In some possible implementations, after receiving the indication information, the user equipment 101 can determine when to stop the duration for skipping PDCCH monitoring, that is, when to resume PDCCH monitoring, by itself in combination with the subsequent communication process.

In some possible implementations, starting from the effective timing of the indication information, the network device 102 suspends PDCCH transmission, and the user equipment 101 starts skipping PDCCH monitoring.

In one example, the network device 102 may suspend sending a specific type of PDCCH. For example, the network device 102 may suspend sending DCI of a specific DCI format, or suspend sending DCI of a specific search space.

In one example, when the network device 102 suspends sending a specific type of PDCCH, the user equipment 101 correspondingly skips monitoring the specific type of PDCCH. For example, the user equipment 101 skips monitoring DCI of a specific DCI format, or skip monitoring DCI of a specific search space.

In some possible implementations, the indication information may be effective from the next time slot of the time slot in which the UE receives the indication information.

In one example, the user equipment 101 receives the indication information in the N-th time slot, and the effective timing of the indication information is the start timing of the (N+1)-th time slot.

In some possible implementations, the user equipment 101 is in an energy-saving state during the period for skipping PDCCH monitoring to achieve energy saving.

In one example, the energy-saving state of the user equipment 101 may include a deep sleep state, a light sleep state, and a micro sleep state.

In some possible implementations, a timing when the user equipment 101 stops skipping PDCCH monitoring, that is, a timing when the user equipment 101 resumes the monitoring of PDCCH is recorded as a first timing.

In one example, the first timing is a timing when the user equipment 101 receives the low power wake up signal (LP WUS).

In another example, the user equipment 101 determines the first timing to be the end time of a maximum duration according to the maximum duration configured by the network device 102.

In some possible implementations, the user equipment 101 is in an energy-saving state during the period from the effective timing of the indication information to the first timing, and skips the PDCCH monitoring. And during this period, the low power receiver monitors LP WUS.

In some possible implementations, after the first timing, the user equipment 101 wakes up and resumes monitoring PDCCH.

In the embodiment of the present disclosure, the user equipment 101 obtains the duration for skipping PDCCH monitoring in the non-numerical value configured by the network device 102 according to the indication information sent by the network device 102, so that the user equipment 101 can adaptively skip PDCCH monitoring in combination with the communication situation, and realize flexible skipping and recovery of PDCCH monitoring on the basis of saving energy.

The embodiment of the present disclosure provides a method for receiving indication information, which is performed by the user equipment 101. Referring to FIG. 3, FIG. 3 is a method for receiving indication information according to an example embodiment. As shown in FIG. 3, the method includes steps S301˜S302, specifically:

Step S301, the user equipment 101 receives indication information sent by the network device 102, and the indication information is configured to indicate a duration for skipping PDCCH monitoring in a form of non-numerical value.

Step S302, the user equipment 101 skips PDCCH monitoring according to the indication information.

In some possible implementations, after receiving the indication information, the user equipment 101 can determine when to stop the duration for skipping PDOCH monitoring, that is, when to resume monitoring PDCCH, by itself in combination with the subsequent communication process.

In some possible implementations, the user equipment 101 is in an energy-saving state during the period for skipping PDCCH monitoring to achieve energy saving.

In an example, the energy-saving state of the user equipment 101 may include a deep sleep state, a light sleep state, and a micro sleep state.

In the embodiment of the present disclosure, the user equipment 101 obtains the duration for skipping PDCCH monitoring in the non-numerical value configured by the network device 102 according to the indication information sent by the network device 102, so that the user equipment 101 can adaptively skip PDCCH monitoring in combination with the communication situation, and realize flexible skipping of PDCCH monitoring on the basis of saving energy.

The embodiment of the present disclosure provides a method for receiving indication information, which is performed by the user equipment 101. The method includes steps S301 to S302′, specifically:

Step S301, the user equipment 101 receives indication information sent by the network device 102, and the indication information is configured to indicate a duration for skipping physical downlink control channel PDCCH monitoring in a form of non-numerical value.

Step S302′, from an effective timing of the indication information to the first timing, a primary receiver of the user equipment 101 is in a sleep state and skips the PDCCH monitoring.

In some possible implementations, the user equipment 101 includes a primary receiver and a low-power receiver.

In some possible implementations, from the effective timing to the first timing, the primary receiver is in a sleep state and skips the PDCCH monitoring. The primary receiver is in a sleep state, which indicates that the user equipment 101 is in a sleep state.

In some possible implementations, from the effective timing to the first timing, the low-power receiver is kept turned on. The low-power receiver has a small power and can still ensure energy saving in the sleep state of the user equipment 101.

The low-power transceiver is configured to monitor and receive LP WUS. Before receiving WUS, the primary receiver remains in a sleep state to achieve energy saving. After receiving LP WUS, the primary receiver is awakened to perform operations such as data transmission and reception.

In some possible implementations, the network device 102 sends LP WUS when there is a need to send downlink information; otherwise, the network device 102 does not send LP WUS.

In some possible implementations, the user equipment 101 receives indication information in the N-th time slot, and the effective timing of the indication information is the start timing of the (N+1)-th time slot.

In the embodiment of the present disclosure, after receiving the indication information, the user equipment 101 makes the primary receiver sleep and skips PDCCH monitoring between the effective timing of the indication information and the first timing to achieve energy saving.

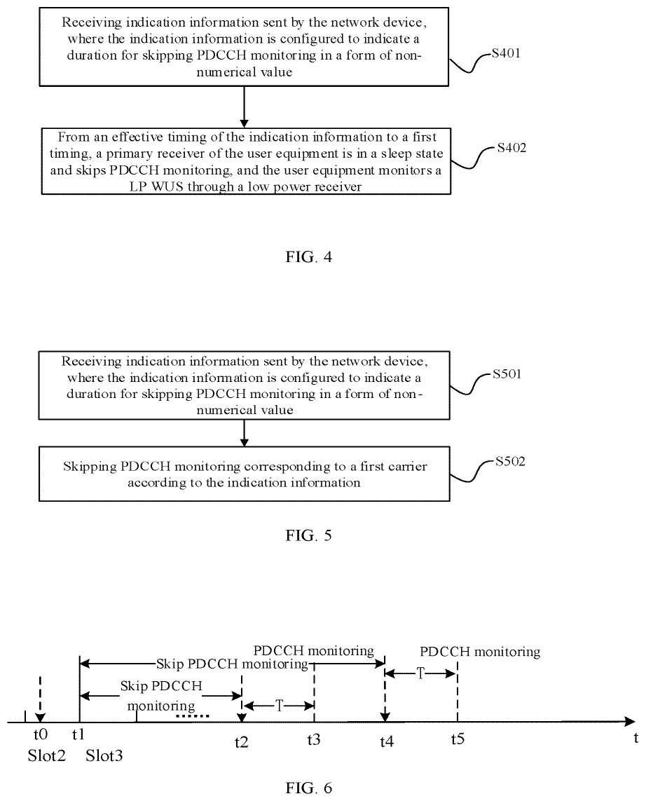

The embodiment of the present disclosure provides a method for receiving indication information, which is performed by the user equipment 101. Referring to FIG. 4. FIG. 4 is a method for receiving indication information according to an example embodiment. As shown in FIG. 4, the method includes steps S401 to S402. Specifically:

Step S401, the user equipment 101 receives indication information sent by the network device 102, and the indication information is configured to indicate a duration for skipping physical downlink control channel PDCCH monitoring in a form of non-numerical value.

Step S402, from an effective timing of the indication information to a first timing, a primary receiver of the user equipment 101 is in a sleep state and skips the PDCCH monitoring, and the user equipment 101 monitors a low power wake-up signal LP WUS through a low power receiver.

In some possible implementations, after the first timing, the primary receiver of the user equipment 101 wakes up and resumes monitoring the PDCCH.

In the embodiment of the present disclosure, the user equipment 101 can determine the first timing in combination with the communication situation, so as to adaptively skip or resume PDCCH monitoring based on the indication information, which can achieve both energy saving and timely reception of downlink data to reduce data transmission delay.

The embodiment of the present disclosure provides a method for receiving indication information, which is performed by the user equipment 101. The method includes steps S401 to S402, specifically:

Step S401, the user equipment 101 receives indication information sent by the network device 102, and the indication information is configured to indicate a duration for skipping physical downlink control channel PDCCH monitoring in a form of non-numerical value.

Step S402, from an effective timing of the indication information to a first timing, a primary receiver of the user equipment 101 is in a sleep state and skips the PDCCH monitoring, and the user equipment 101 monitors a low-power wake-up signal LP WUS through a low-power receiver. The first timing is a timing when the LP WUS is monitored.

In some possible implementations, when the low-power receiver monitors (i.e. receives) LP WUS, it indicates that the network device 102 may have a downlink data scheduling requirement, so the primary receiver can be awakened from the first timing.

In some possible implementations, the primary receiver may be awakened within a certain wake-up delay T. Therefore, the primary receiver can start to monitor the PDCCH after the duration T since the first timing.

In some possible implementations, when the primary receiver is in different sleep states, the corresponding wake-up delays may be different. For example, the wake-up delay corresponding to the deep sleep state is T1, the wake-up delay corresponding to the light sleep state is T2, and the wake-up delay corresponding to the micro sleep state is T3, where T1>T2>T3.

In the embodiment of the present disclosure, the user equipment 101 wakes up according to the LP WUS of the network device 102, resumes PDCCH monitoring, and receives downlink data in time to reduce the data transmission delay.

In the embodiment of the present disclosure, a method for receiving indication information is provided, which is performed by the user equipment 101, The method includes steps S401 and S402, specifically:

Step S401, the user equipment 101 receives indication information sent by the network device 102, and the indication information is configured to indicate a duration for skipping physical downlink control channel PDCCH monitoring in a form of non-numerical value.

The indication information is also configured to indicate a maximum duration for skipping PDCCH monitoring.

Step S402, from an effective timing of the indication information to a first timing, a primary receiver of the user equipment 101 is in a sleep state and skips the PDCCH monitoring, and the user equipment 101 monitors a low-power wake-up signal LP WUS through a low-power receiver. If LP WUS is not received within the maximum duration, the first timing is an end timing of the maximum duration.

In some possible implementations, the maximum duration can also be dynamically configured by the network device 102. For example, the maximum duration is configured separately from the duration for skipping PDCCH monitoring indicating a non-numeric value.

In some possible implementations, the primary receiver can start monitoring PDCCH after duration T (wake-up delay) since the first timing.

In some possible implementations, when the primary receiver is in different sleep states, the corresponding wake-up delays may be different. For example, the wake-up delay corresponding to the deep sleep state is T1, the wake-up delay corresponding to the light sleep state is T2, and the wake-up delay corresponding to the micro sleep state is T3, where T1>T2>T3.

In the embodiment of the present disclosure, in the scenario where the LP WUS is not monitored, the user equipment 101 determines the first timing in combination with the maximum duration configured by the network device 102, so as to timely monitor the PDCCH and receive downlink data in time, thereby reducing the data transmission delay.

The embodiment of the present disclosure provides a method for receiving indication information, which is performed by the user equipment 101. Referring to FIG. 5, FIG. 5 is a method for receiving indication information according to an example embodiment. As shown in FIG. 5, the method includes steps S501˜S502, specifically:

Step S501, the user equipment 101 receives the indication information sent by the network device 102, and the indication information is configured to indicate a duration for skipping physical downlink control channel PDCCH monitoring in a form of non-numerical value.

Step S502, the user equipment 101 skips the PDCCH monitoring corresponding to a first carrier according to the indication information.

In some possible implementations, the first carrier may be a serving carrier of the user equipment 101.

In some possible implementations, in the scenario of carrier aggregation, the first carrier may be multiple serving carriers or a primary carrier corresponding to the user equipment 101.

In some possible implementations, the first carrier includes one of the following:
all serving carriers corresponding to the user equipment in the carrier aggregation scenario;
a carrier on which the indication information is sent; and
a primary carrier corresponding to the user equipment in the carrier aggregation scenario.

In one example, each component carrier in the carrier aggregation serves as a serving carrier for the user equipment 101. That is, the number of serving carriers is the same as the number of component carriers.

In one example, the serving carriers includes a primary carrier and multiple secondary carriers. The primary carrier can be configured to send control information such as paging messages and system message broadcasts. The user equipment 101 can monitor system information only on the primary carrier.

In one example, the primary carrier can be selected by the network device 102 for the user equipment 101.

In one example, the carrier on which the indication information is sent may be either a primary carrier or a secondary carrier.

In the embodiment of the present disclosure, the user equipment 101 skips the PDCCH monitoring corresponding to a specific carrier according to the indication information.

In the embodiment of the present disclosure, a method for receiving indication information is provided, and the method is performed by the user equipment 101. The method includes steps S401 to S403, specifically:

Step S401, the user equipment 101 receives indication information sent by the network device 102, and the indication information is configured to indicate a duration of skipping physical downlink control channel PDCCH monitoring in a form of non-numerical value.

Step S402, from an effective timing of the indication information to a first timing, a primary receiver of the user equipment 101 is in a sleep state and skips the PDCCH monitoring, and the user equipment 101 monitors a low power wake-up signal LP WUS through a low power receiver.

Step S403, after the first timing, the primary receiver is converted from the sleep state to the working state, and monitors the PDCCH.

In some possible implementations, the user equipment 101 receives the indication information in the N-th time slot, and the effective timing of the indication information is the start timing of the (N+1)-th time slot.

In some possible implementations, during the period from the effective timing to the first timing, the primary receiver sleeps to achieve energy saving. Only the low-power receiver can be kept turned on to monitor the LP WUS.

In some possible implementations, the first timing is a timing when the user equipment 101 receives the LP WUS.

For example, when the low-power receiver monitors the LP WUS, it indicates that the network device 102 may have a downlink data scheduling requirement. At this first timing, the UE ends the skipping of PDCCH monitoring and starts to wake up the primary receiver.

In some possible implementations, the first timing is the end timing of the maximum duration configured by the network device 102.

For example, the indication information is also configured to indicate the maximum duration of skipping PDCCH monitoring. The first timing is the end timing of the maximum duration. At this first timing, the UE ends the skipping of PDCCH monitoring and starts to wake up the primary receiver.

In some possible implementations, the primary receiver may wake up within a certain wake-up delay T. Therefore, the primary receiver may start to monitor the PDCCH after the duration T since the first timing.

In some possible implementations, when the primary receiver is in different sleep states, the corresponding wake-up delays may be different. For example, the wake-up delay corresponding to the deep sleep state is T1, the wake-up delay corresponding to the light sleep state is T2, and the wake-up delay corresponding to the micro sleep state is T3, where T1>T2>T3.

In one example:

As shown in FIG. 6, the user equipment 101 receives the indication information at 10 in the N-th time slot, and the effective timing of the indication information is the start timing t1 of the (N+1)-th time slot, where N=2.

Starting from t1, the network device 102 suspends PDCCH transmission. The network device 102 may suspend sending a specific type of PDCCH, for example, suspend sending DCI of a specific DCI format, or suspend sending DCI of a specific search space.

And starting from t1, the primary receiver of the user equipment 101 is in a sleep state, and skips PDCCH monitoring, and the low-power receiver monitors LP WUS. Corresponding to the PDCCH that the network device 102 suspends sending, the user equipment 101 may skip monitoring of the specific type of PDCCH. For example, the user equipment 101 skips monitoring DCI of a specific DCI format, or skips monitoring DCI of a specific search space.

If the low-power receiver receives LP WUS at t2, then 12 is the first timing, and the primary receiver is awakened from t2. If the wake-up delay of the primary receiver is T, the primary receiver wakes up at t3 after T since t2, and can monitor PDCCH. At this time, the duration for skipping PDCCH monitoring is t1˜t2.

If the low-power receiver has not received LP WUS, the end timing t4 of the maximum duration is taken as the first timing, and the primary receiver is awakened from t4. If the wake-up delay of the primary receiver is T, the primary receiver wakes up at t5 after T since t4, and can monitor PDCCH. At this time, the duration for skipping PDCCH monitoring is t1˜t4.

In the embodiment of the present disclosure, the user equipment 101 can skip PDCCH monitoring and resume PDCCH monitoring at an appropriate timing in combination with the indication information, and receive downlink data in a timely manner on the basis of effective energy saving to reduce data transmission delay.

The embodiment of the present disclosure provides a method for receiving indication information, which is performed by the user equipment 101. The method includes steps S401 to S403′, specifically:

Step S401, the user equipment 101 receives indication information sent by the network device 102, and the indication information is configured to indicate a duration for skipping physical downlink control channel PDCCH monitoring in a form of non-numerical value.

Step S402, from an effective timing of the indication information to a first timing, a primary receiver of the user equipment 101 is in a sleep state and skips the PDCCH monitoring, and the user equipment 101 monitors a low power wake-up signal LP WUS through a low power receiver.

Step S403′, after the first timing, the primary receiver is converted from a sleep state to a working state, and monitors the PDCCH corresponding to a second carrier.

In some possible implementations, the second carrier may be a serving carrier of the user equipment 101.

In some possible implementations, in the carrier aggregation scenario, the second carrier may be all or part of the serving carriers of the user equipment 101.

In some possible implementations, the second carrier includes one of the following:
all or part of the serving carriers corresponding to the user equipment in the carrier aggregation scenario;
a carrier on which the indication information is sent; and
a primary carrier corresponding to the user equipment in the carrier aggregation scenario.

In one example, the network device 102 may pre-configure a default serving carrier among multiple serving carriers. In this scenario, the user equipment 101 only restores the PDCCH monitoring of the default serving carrier.

In one example, the user equipment 101 may only restore the PDCCH monitoring of the primary carrier.

In one example, the user equipment 101 may only restore the PDCCH monitoring of the secondary carrier.

In some possible implementations, the second carrier is the same as the first carrier. For example, when the first carrier is the primary carrier, the second carrier also refers to the primary carrier.

In some possible implementations, the LP WUS monitored by the low-power receiver includes an information field for indicating the second carrier index.

In one example, the information field may occupy 1 or 2 bits.

For example, two second carrier indexes are indicated by 1 bit respectively. When the 1 bit is 0, it corresponds to CC1, and when the 1 bit is 1, it corresponds to CC2.

For another example, four second carrier indexes are indicated by 2 bits respectively. When the 2 bits are 00, it corresponds to CC1; when the 1 bit is 10, it corresponds to CC2; when the 2 bits are 01, it corresponds to CC3; when the 2 bits are 11, it corresponds to CC4.

In the embodiment of the present disclosure, the user equipment 101 can resume PDCCH monitoring of some or all carriers to selectively receive data.

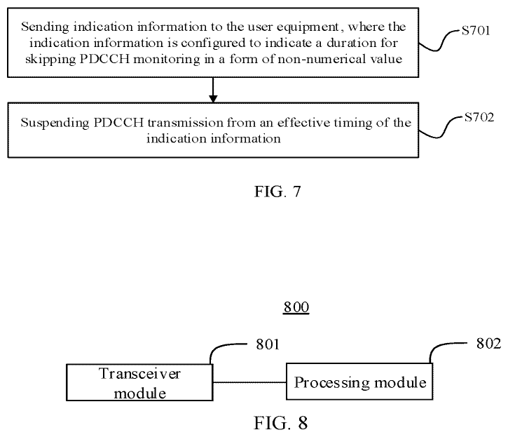

The embodiment of the present disclosure provides a method for sending indication information, which is performed by the network device 102. Referring to FIG. 7, FIG. 7 is a method for sending indication information according to an example embodiment. As shown in FIG. 7, the method includes steps S701˜S702, specifically:

Step S701, the network device 102 sends indication information to the user equipment 101, and the indication information is configured to indicate a duration for skipping physical downlink control channel PDCCH monitoring in a form of non-numerical value.

Step S702, from an effective timing of the indication information, the network device 102 suspends PDCCH transmission.

In some possible implementations, when the network device 102 configures a duration for skipping PDCCH monitoring in a non-numerical value, it indicates that the network device 102 does not indicate a specific duration, and does not determine when the user equipment 101 needs to be woken up.

In some possible implementations, starting from the effective timing of the indication information, the network device 102 suspends PDCCH transmission, and the user equipment 101 starts to skip monitoring PDCCH.

In one example, the network device 102 may suspend sending a specific type of PDCCH. For example, the network device 102 suspends sending DCI of a specific DCI format, or suspends sending DCI of a specific search space.

In one example, when the network device 102 suspends sending a specific type of PDCCH, the user equipment 101 correspondingly skips monitoring of the specific type of PDCCH. For example, the user equipment 101 skips monitoring DCI of a specific DCI format, or skips monitoring DCI of a specific search space.

In some possible implementations, the user equipment 101 receives the indication information in the N-th time slot, and the effective timing of the indication information is the starting timing of the (N+1)-th time slot.

In the embodiment of the present disclosure, the network device 102 sends the indication information to the user equipment 101 to notify the user equipment 101 of the configured duration for skipping PDCCH monitoring in the non-numerical value, so that the user equipment 101 can adaptively skip PDCCH monitoring in combination with the communication situation, and flexibly achieve the skipping of PDCCH monitoring on the basis of saving energy.

The embodiment of the present disclosure provides a method for sending indication information, which is performed by the network device 102. The method includes steps S701˜S702, specifically;

Step S701, the network device 102 sends indication information to the user equipment 101, and the indication information is configured to indicate a duration for skipping physical downlink control channel PDCCH monitoring in a form of non-numerical value.

Step S702, starting from an effective timing of the indication information, the network device 102 suspends PDCCH transmission.

The indication information is also configured to indicate the maximum duration for skipping PDCCH monitoring.

In the embodiment of the present disclosure, it is applicable to the scenario where LP WUS is not sent, and the user equipment 101 can determine the first timing according to the maximum duration, and wake up the primary receiver to monitor PDCCH after the first timing.

The embodiment of the present disclosure provides a method for sending indication information, which is performed by the network device 102. The method includes steps S701˜S703, specifically:

Step S701, the network device 102 sends indication information to the user equipment 101, and the indication information is configured to indicate a duration for skipping physical downlink control channel PDCCH monitoring in a form of non-numerical value.

Step S702, starting from an effective timing of the indication information, the network device 102 suspends PDCCH transmission.

Step S703, the network device 102 sends LP WUS to the user equipment 101.

In some possible implementations, the network device 102 corresponds to a first carrier, and the user equipment 101 skips monitoring the PDCCH of the first carrier from the effective timing to the first timing.

In some possible implementations, the first carrier may be a primary carrier, or a serving carrier, or a carrier carrying the indication information.

In some possible implementations, the network device 102 will send the LP WUS only when there is a downlink data scheduling requirement.

In some possible implementations, the network device 102 may send the LP WUS by broadcasting.

In some possible implementations, before sending the LP WUS, the network device 102 may send the configuration information of the LP WUS so that the user equipment 101 can monitor and receive the LP WUS according to the resource configuration of the LP WUS.

In some possible implementations, after receiving the LP WUS, the user equipment 101 may wake up the primary receiver to monitor the PDCCH.

In some possible implementations, the user equipment 101 may resume monitoring the second carrier after waking up again.

In one example, the second carrier is the same as the first carrier.

In one example, the LP WUS includes an information field for indicating the second carrier index. The user equipment 101 determines the second carrier index according to the bit value of the information field, and then determines the second carrier.

In the embodiment of the present disclosure, in the scenario of skipping PDCCH monitoring, the network device 102 can indicate a skipping duration of a non-numerical value, and flexibly wake up the user equipment 101 through the dynamic LP WUS, so that the user equipment 101 resumes PDCCH monitoring, which can not only save the energy of the user equipment 101, but also transmit data based on a suitable skipping period to reduce the transmission delay.

Based on the same concept as the above method embodiment, the embodiment of the present disclosure also provides a device for receiving indication information, which can have the function of the user equipment 101 in the above method embodiment, and can be configured to execute the steps performed by the user equipment 101 provided in the above method embodiment. The function can be implemented by hardware, or by software or by hardware executing corresponding software. The hardware or software includes one or more modules corresponding to the above function.

In a possible implementation, the device 800 shown in FIG. 8 can be used as the user equipment 101 involved in the above method embodiment, and executes the steps performed by the user equipment 101 in the above method embodiment. As shown in FIG. 8, the device 800 may include a transceiver module 801 and a processing module 802 which are coupled to each other. The transceiver module 801 may be configured to support the communication device to communicate, and the processing module 802 may be used for the communication device to perform processing operations, such as generating information/messages to be sent, or processing received signals to obtain information/messages.

When executing the steps implemented by the user equipment 101, the transceiver module 801 is configured to receive indication information sent by the network device, and the indication information is configured to indicate a duration for skipping physical downlink control channel PDCCH monitoring in a form of non-numerical value.

The processing module 802 is configured to skip the PDCCH monitoring according to the indication information.

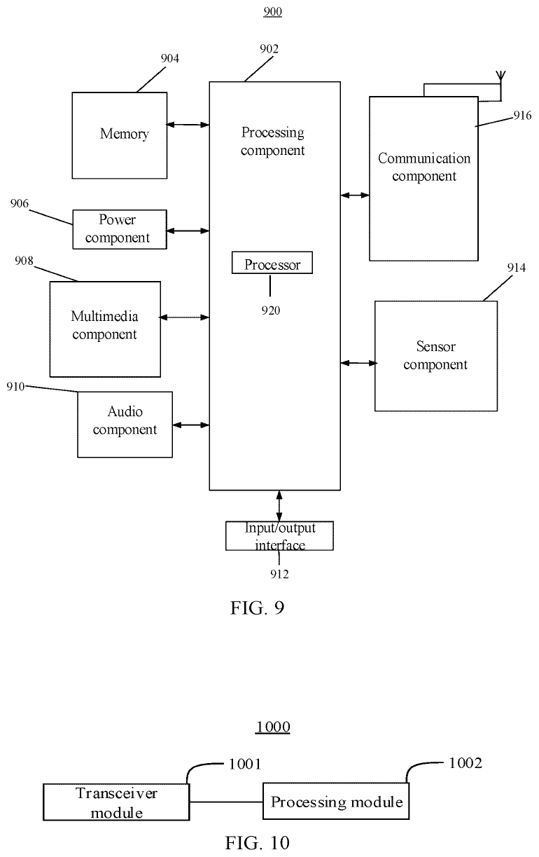

When the device for receiving the configuration information is the user equipment 101, its structure may also be as shown in FIG. 9. The device 900 may be a mobile phone, a computer, a digital broadcast terminal, a message transceiver device, a game console, a tablet device, a medical device, a fitness device, a personal digital assistant, etc.

Referring to FIG. 9, the device 900 may include one or more of the following components: a processing component 902, a memory 904, a power component 906, a multimedia component 908, an audio component 910, an input/output (I/O)) interface 912, a sensor component 914, and a communication component 916.

The processing component 902 generally controls the overall operation of the device 900, such as operations associated with display, phone calls, data communications, camera operations, and recording operations. The processing component 902 may include one or more processors 920 to execute instructions to complete all or part of the steps of the above-mentioned method. In addition, the processing component 902 may include one or more modules to facilitate the interaction between the processing component 902 and other components. For example, the processing component 902 may include a multimedia module to facilitate the interaction between the multimedia component 908 and the processing component 902.

The memory 904 is configured to store various types of data to support the operation of the device 900. Examples of such data include instructions for any application or method operating on the device 900, contact data, phone book data, messages, pictures, videos, etc. The memory 904 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 906 provides power to various components of the device 900. The power component 906 may include a power management system, one or more power supplies, and other components associated with generating, managing, and distributing power for the device 900.

The multimedia component 908 includes a screen that provides an output interface between the device 900 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor may not only sense the boundaries of a touch or slide action, but also detect the duration and pressure associated with the touch or slide operation. In some embodiments, the multimedia component 908 includes a front camera and/or a rear camera. When the device 900 is in an operating mode, such as a shooting mode or a video mode, the front camera and/or the rear camera can receive external multimedia data. Each of the front camera and the rear camera can be a fixed optical lens system or have focal length and optical zoom capabilities.

The audio component 910 is configured to output and/or input audio signals. For example, the audio component 910 includes a microphone (MIC), and when the device 1000 is in an operating mode, such as a call mode, a recording mode, and a voice recognition mode, the microphone is configured to receive an external audio signal. The received audio signal can be further stored in the memory 904 or sent via the communication component 916. In some embodiments, the audio component 910 also includes a speaker for outputting audio signals.

The I/O interface 912 provides an interface between the processing component 902 and the peripheral interface module, which can be a keyboard, a click wheel, a button, etc. These buttons may include, but are not limited to, a home button, a volume button, a start button, and a lock button.

The sensor assembly 914 includes one or more sensors for providing various aspects of the status assessment of the device 900. For example, the sensor assembly 914 can detect the open/closed state of the device 900, the relative positioning of components, such as the display and keypad of the device 900. The sensor assembly 914 can also detect the position change of the device 900 or a component of the device 900, the presence or absence of user contact with the device 900, the orientation or acceleration/deceleration of the device 900, and the temperature change of the device 900. The sensor assembly 914 can include a proximity sensor configured to detect the presence of nearby objects without any physical contact. The sensor assembly 914 can also include a light sensor, such as a CMOS or CCD image sensor, for use in imaging applications. In some embodiments, the sensor assembly 914 can also include an acceleration sensor, a gyroscope sensor, a magnetic sensor, a pressure sensor, or a temperature sensor.

The communication component 916 is configured to facilitate wired or wireless communication between the device 900 and other devices. The device 900 can access a wireless network based on a communication standard, such as WiFi, 2G or 3G, or a combination thereof. In an example embodiment, the communication component 916 receives a broadcast signal or broadcast related information from an external broadcast management system via a broadcast channel. In an example embodiment, the communication component 916 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an example embodiment, the device 900 can be implemented by one or more of an application-specific integrated circuit (ASIC), a digital signal processor (DSP), a digital signal processing device (DSPD), a programmable logic device (PLD), a field programmable gate array (FPGA), a controller, a microcontroller, a microprocessor or other electronic component for performing the above method.

In an example embodiment, a non-transitory computer-readable storage medium including instructions is also provided, such as a memory 904 including instructions, and the above instructions can be executed by a processor 920 of the device 900 to complete the above method. For example, the non-transitory computer-readable storage medium can be a ROM, a random access memory (RAM), a CD-ROM, a tape, a floppy disk, an optical data storage device, etc.

Based on the same concept as the above method embodiment, the embodiment of the present disclosure also provides a device for sending indication information, which may have the function of the network device 102 in the above method embodiment, and may be configured to execute the steps performed by the network device 102 provided by the above method embodiment. The function may be implemented by hardware, or by software or by hardware executing corresponding software. The hardware or software includes one or more modules corresponding to the above functions.

In a possible implementation, the communication device 1000 shown in FIG. 10 may be used as the network device 102 involved in the above method embodiment, and execute the steps performed by the network device 102 in the above method embodiment. As shown in FIG. 10, the communication device 1000 may include a transceiver module 1001 and a processing module 1002 which are coupled to each other. The transceiver module 1001 may be configured to support the communication device to communicate, and the transceiver module 1001 may have a wireless communication function. For example, it can communicate wirelessly with other communication devices through a wireless air interface. The processing module 1002 can be used for the communication device to perform processing operations, such as generating information/messages to be sent, or processing received signals to obtain information/messages.

When executing the steps implemented by the network device 102, the transceiver module 1001 is configured to send indication information to the user equipment, and the indication information is configured to indicate a duration for skipping physical downlink control channel PDCCH monitoring in a form of non-numerical value.

The processing module 1002 is configured to suspend PDCCH transmission from the effective timing of the indication information.

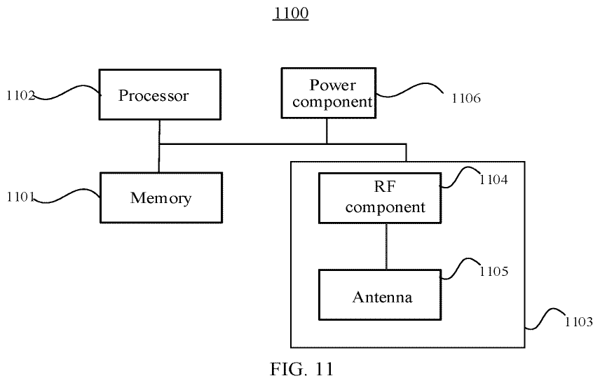

When the communication device is the network device 102, its structure can also be shown in FIG. 11. The structure of the communication device is illustrated by taking a base station as an example. As shown in FIG. 11, the device 1100 includes a memory 1101, a processor 1102, a transceiver component 1103, and a power component 1106. The memory 1101 is coupled with the processor 1102, and can be configured to store the programs and data necessary for the communication device 1100 to implement various functions. The processor 1102 is configured to support the communication device 1100 to perform the corresponding functions in the above method, and the functions can be implemented by calling the program stored in the memory 1101. The transceiver component 1103 may be a wireless transceiver, which may be configured to support the communication device 1100 to receive signaling and/or data through a wireless air interface, and to send signaling and/or data. The transceiver component 1103 may also be referred to as a transceiver unit or a communication unit. The transceiver component 1103 may include a radio frequency component 1104 and one or more antennas 1105, where the radio frequency component 1104 may be a remote radio unit (RRU), which may be specifically configured to transmit radio frequency signals and perform conversion between radio frequency signals and baseband signals, and the one or more antennas 1105 may be configured to radiate and receive radio frequency signals.

When the communication device 1100 needs to send data, the processor 1102 may perform baseband processing on the data to be sent, and then output the baseband signal to the radio frequency unit. The radio frequency unit performs radio frequency processing on the baseband signal and then sends the radio frequency signal through the antenna in the form of electromagnetic waves. When data is sent to the communication device 1100, the radio frequency unit receives the radio frequency signal through the antenna, converts the radio frequency signal into a baseband signal, and outputs the baseband signal to the processor 1102. The processor 1102 converts the baseband signal into data and processes the data.

After considering the specification and practicing the present disclosure herein, it will be easy for those skilled in the art to think of other implementations of the embodiments of the present disclosure. The present disclosure is intended to cover any variation, use or adaptive change of the embodiments of the present disclosure, which follows the general principles of the embodiments of the present disclosure and includes common knowledge or conventional technical means in the technical field not disclosed in the present disclosure. The specification and embodiments are to be regarded as exemplary only, and the true scope and spirit of the embodiments of the present disclosure are indicated by the following claims.

It should be understood that the embodiments of the present disclosure are not limited to the precise structure described above and shown in the drawings, and various modifications and changes can be made without departing from the scope thereof. The scope of the embodiments of the present disclosure is limited only by the appended claims.

### INDUSTRIAL APPLICABILITY

In the method of the present disclosure, the user equipment obtains the duration for skipping PDCCH monitoring in a non-numerical value configured by the network device according to the indication information sent by the network device, so that the user equipment can adaptively skip the PDCCH monitoring according to the communication situation, and flexibly implement the skip of PDCCH monitoring on the basis of saving energy.

1. A method for receiving indication information, performed by a user equipment, comprising:
receiving indication information sent by a network device, wherein the indication information is configured to indicate a duration for skipping physical downlink control channel (PDCCH) monitoring in a form of non-numerical value; and
skipping PDCCH monitoring according to the indication information.

2. The method according to claim 1, wherein skipping PDCCH monitoring according to the indication information comprises:
from an effective timing of the indication information to a first timing, a primary receiver of the user equipment is in a sleep state and skips PDCCH monitoring, and the user equipment monitors a low power wake-up signal (LP WUS) through a low power receiver.

3. The method according to claim 2, wherein the first timing is a timing when the LP WUS is monitored.

4. The method according to claim 2, wherein the indication information is further configured to indicate a maximum duration for skipping PDCCH monitoring; and
in a case where the LP WUS is not received within the maximum duration, the first timing is an end timing of the maximum duration.

5. The method according to claim 1, wherein skipping PDCCH monitoring according to the indication information comprises:
skipping PDCCH monitoring corresponding to a first carrier according to the indication information.

6. The method according to claim 5, wherein the first carrier comprises one of:
all serving carriers corresponding to the user equipment in a carrier aggregation scenario;
a carrier on which the indication information is sent; and
a primary carrier corresponding to the user equipment in the carrier aggregation scenario.

7. The method according to claim 2, further comprising:
after the first timing, the primary receiver switches from a sleep state to a working state and monitors PDCCH.

8. The method according to claim 7, wherein monitoring the PDCCH comprises:
monitoring the PDCCH corresponding to a second carrier.

9. The method according to claim 8, wherein the second carrier comprises one of:
all or part of serving carriers corresponding to the user equipment in a carrier aggregation scenario;
a carrier on which the indication information is sent; and
a primary carrier corresponding to the user equipment in the carrier aggregation scenario.

10. The method according to claim 8, wherein the second carrier is same as the first carrier.

11. The method according to claim 8, wherein
the LP WUS monitored by the low-power receiver comprises an information field for indicating a second carrier index.

12. A method for sending indication information, performed by a network device, comprising:
sending indication information to a user equipment, wherein the indication information is configured to indicate a duration for skipping physical downlink control channel (PDCCH) monitoring in a form of non-numerical value; and
from an effective timing of the indication information, suspending PDCCH transmission.

13. The method according to claim 12, wherein the indication information is further configured to indicate a maximum duration for skipping PDCCH monitoring.

14. The method according to claim 12, further comprising:
sending a low power wake-up signal (LP WUS) to the user equipment.

15. The method according to claim 14, wherein the LP WUS comprises an information field for indicating a second carrier index.

16-17. (canceled)

18. A communication device, comprising a processor and a memory, wherein
the memory is configured to store a computer program; and
the processor is configured to execute the computer program to:
receive indication information sent by a network device, wherein the indication information is configured to indicate a duration for skipping physical downlink control channel (PDCCH) monitoring in a form of non-numerical value; and
skip PDCCH monitoring according to the indication information.

19. A communication device, comprising a processor and a memory, wherein
the memory is configured to store a computer program; and
the processor is configured to execute the computer program to implement the method according to claim 12.

20. A non-transitory computer-readable storage medium, wherein the computer-readable storage medium stores instructions, and when the instructions are called and executed on a computer, the computer executes the method according to claim 1.

21. A non-transitory computer-readable storage medium, wherein instructions are stored in the computer-readable storage medium, and when the instructions are called and executed on a computer, the computer executes the method according to claim 12.
